(19) United States
(12) Patent Application Publication
(10) Pub. No.: US 2025/0335342 A1
(43) Pub. Date: Oct. 30, 2025

(54) AI EXCEPTION INTERPRETER

(71) Applicant: Microsoft Technology Licensing, LLC, Redmond, WA (US)

(72) Inventors: Martin Peter CHECK, Redmond, WA (US); Brian Scott WATERS, McDonough, GA (US); Anthony Lawayne FAULDS, Seattle, WA (US); Virender Singh JAMNAL, Redmond, WA (US); Sashikanth S. ABBURI, Redmond, WA (US); Luke Callahan RUCKER, Atlanta, GA (US); Mohammad Ifakharul KARIM, Atlanta, GA (US); Hongyu MIAO, Atlanta, GA (US); Venkatesh GUDE, Atlanta, GA (US); Akansha MALIK, Atlanta, GA (US)

(21) Appl. No.: 18/645,187

(22) Filed: Apr. 24, 2024

(51) Int. Cl. G06F 11/36

(52) U.S. Cl. CPC G06F 11/3692

(57) ABSTRACT

Example solutions for providing an artificial intelligence (AI) exception interpreter are disclosed. An exception interpreter receives an exception report from a software application, evaluates it (using AI), and generates a first exception handling response. This provides the benefit of learning over a large amount of exception handling data, which offers super performance over trial-and-error tactics by programmers who are either less experienced or unfamiliar with exceptions from third party resources. Some examples sanitize exception reports of sensitive information. Some examples track an exception event history, so that when the same exception is seen multiple times (meaning a prior response was not effective), a different exception handling response may be provided.

### BACKGROUND

When executing a software application (program), different errors can occur such as, from coding errors made by the programmer, errors due to incorrect input, an expected resource being unavailable, and/or other events/situations. In software engineering, an exception is a type of error that occurs during program execution and disrupts the normal flow of instructions, but from which the program can recover in some scenarios. Common exceptions include an invalid argument (e.g. a value is outside of the domain of a function), an unavailable resource (e.g., a missing file, a network drive error, or out-of-memory errors), or that the application has detected a condition that requires special handling (e.g., end of file).

Development resources, such as time, may be lost or wasted when a programmer lacks expertise to optimally address an exception and either uses a trial-and-error approach, or seeks advice from an unreliable source, such as random locations on the internet. The problem is worsened when the exception is from a third party resource, such as an external API, because the variety of causes and best responses is so widely varied that the needed expertise may be beyond even skilled programmers, and the possibility of unhelpful information may also increase significantly.

### SUMMARY

The disclosed examples are described in detail below with reference to the accompanying drawing figures listed below. The following summary is provided to illustrate some examples disclosed herein.

Example solutions for providing an artificial intelligence (AI) exception interpreter include: receiving, by an exception interpreter, a first exception report from a software application; evaluating the first exception report, by an evaluator, to identify an exception from a third party resource; generating a first exception handling response based on at least the exception, the first exception handling response comprising an instruction for responding to the exception; and transmitting, to the software application or an environment in which the software application is executing, the first exception handling response.

Additional examples include: programming a software application in an IDE, wherein programming the software application to transmit the first exception report to the exception interpreter comprises: providing, in source code of the software application, a try passage and a catch passage, wherein the try passage comprises a first instruction that is operable to cause a first exception, wherein the catch passage is operable to catch the first exception, and wherein the catch passage comprises a second instruction that is operable to transmit the first exception report to the exception interpreter, the first exception report indicating the exception; executing the software application, wherein executing the software application comprises: executing the first instruction in the try passage, wherein executing the first instruction causes the exception; catching first exception by the catch passage; and executing the second instruction to transmit the first exception report to the exception interpreter; receiving the first exception handling response; and performing, by the software application or the IDE, the instruction indicated in the first exception handling response.

Additional examples also include: receiving, by an exception interpreter, a first exception report from a software application; evaluating the first exception report and an exception event history, by an evaluator, to generate a first exception handling response; transmitting, to the software application or an environment in which the software application is executing, the first exception handling response; adding the first exception report and the first exception handling response to the exception event history; receiving, by the exception interpreter, a second exception report from the software application, the second exception report indicating the same exception as was indicated by the first exception report; evaluating the second exception report and the exception event history, by the evaluator, to generate a second exception handling response different than the first exception handling response; and transmitting, to the software application or an environment in which the software application is executing, the second exception handling response.

Additional examples also include: receiving, by an exception interpreter, a first exception report from a software application; identifying, within the first exception report, sensitive information; based on at least identifying the sensitive information within the first exception report, sanitizing the first exception report of sensitive information; evaluating the first exception report, by an evaluator, to generate a first exception handling response; and transmitting, to the software application or an environment in which the software application is executing, the first exception handling response.

### BRIEF DESCRIPTION OF THE DRAWINGS

The disclosed examples are described in detail below with reference to the accompanying drawing figures listed below:

FIG. 1 illustrates an exemplary architecture that advantageously provides an artificial intelligence (AI) exception interpreter service;

FIGS. 2A, 2B, and 2C illustrate a software application in various forms that may be used with examples of the architecture of FIG. 1;

FIG. 3 illustrates a training arrangement that may be used with examples of the architecture of FIG. 1;

FIG. 4 shows a flowchart illustrating exemplary operations that may be performed when using examples of the training arrangement of FIG. 3 and examples of the architecture of FIG. 1;

FIGS. 5 and 6 show flowcharts illustrating exemplary operations that may be performed by examples of the architecture of FIG. 1;

FIGS. 7A, 7B, 7C, and 7D show additional flowcharts illustrating exemplary operations that may be performed when using example architectures, such as the architecture of FIG. 1; and

FIG. 8 shows a block diagram of an example computing device suitable for implementing some of the various examples disclosed herein.

Corresponding reference characters indicate corresponding parts throughout the drawings.

### DETAILED DESCRIPTION

Example solutions for providing an artificial intelligence (AI) exception interpreter are disclosed. An exception interpreter receives an exception report from a software application, evaluates it (using AI), and generates a first exception handling response. This provides the benefit of learning over a large amount of exception handling data, which offers superior performance over trial-and-error tactics by programmers who are either less experienced or unfamiliar with exceptions from third party resources. Some examples sanitize exception reports of sensitive information. Some examples track an exception event history, so that when the same exception is seen multiple times (meaning a prior response was not effective), a different exception handling response may be provided.

Aspects of the disclosure solve multiple problems that are necessarily rooted in computer technology, such as improving the programming and operation of software applications, for example to improve handle run time exceptions, resulting in more reliable, flexible, and/or faster execution. This is accomplished, at least in part, by evaluating an exception report, by an evaluator (of an exception interpreter), to generate an exception handling response.

The various examples will be described in detail with reference to the accompanying drawings. Wherever preferable, the same reference numbers will be used throughout the drawings to refer to the same or like parts. References made throughout this disclosure relating to specific examples and implementations are provided solely for illustrative purposes but, unless indicated to the contrary, are not meant to limit all examples.

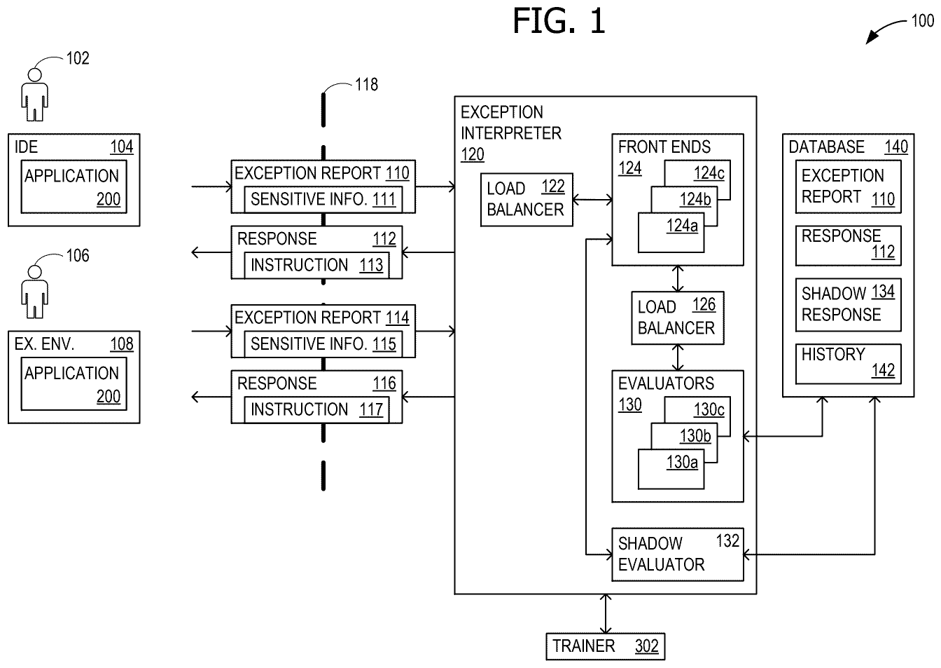

FIG. 1 illustrates an example architecture 100 that advantageously provides an AI exception interpreter as a service. A programmer 102 is using an integrated development environment (IDE) 104 to develop (program) a software application 200. IDE 104 may comprise Visual Studio in some examples, or another software development platform. In some examples, IDE 104 comprises Dot Net (“.Net”). In some examples, software application 200 comprises an interpreted language program, although in other examples, software application 200 may be compiled. At a later time, after deployment, a user 106 will be using software application 200 in an environment 108 (e.g., an execution environment, such as a production environment), which may be an environment for executing an interpreted language or a platform for executing a compiled language program.

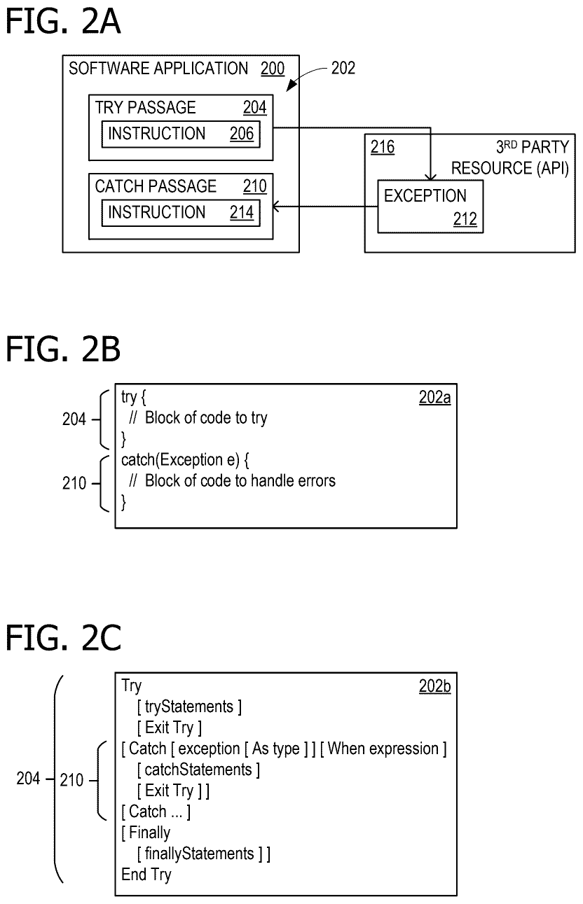

In scenarios described herein, software application 200 throws at least one exception (shown in FIG. 2A), and an exception report 110 is transmitted to an exception interpreter 120. Exception interpreter 120 may be provided as a cloud service, behind a firewall 118, and IDE 104 is connected to the cloud service hosting exception interpreter 120. Some versions of IDE 104 facilitate communication between software application 200 and exception interpreter 120. In other examples, software application 200 is able to communicate with exception interpreter 120 outside of IDE 104, for example, when executing within environment 108.

In scenarios described herein, software application 200 first transmits exception report 110 to exception interpreter 120, exception interpreter 120 responds with exception handling response 112, software application 200 then transmits exception report 114 to exception interpreter 120, and exception interpreter 120 responds with exception handling response 116. In some scenarios, exception report 110 contains sensitive information 111, and exception report 114 contains sensitive information 115. Exception interpreter 120 sanitizes exception report 110 of sensitive information 111 and exception report 114 of sensitive information 115, such as by removing personally identifiable information (PII or personal information, PI).

Exception handling response 112 indicates an instruction 113 for software application 200 or programmer 102 to take as a suggested resolution. Examples may include retry, wait and retry, try a different resource, abort a process, generate an alarm, suggest an instruction change, and change syntax of an instructions in software application 200. If instruction 113 is not successful at preventing another one of the same exception, exception handling response 116 indicates a different instruction 117 for software application 200 or programmer 102 to take as a suggested resolution.

Exception interpreter 120 has a load balancer 122 that selects from among a plurality of exception interpreter service front ends 124, such as a front end 124a, a front end 124b, and a front end 124c, to sanitize exception report 110 and exception report 114. Exception interpreter 120 also has a load balancer 126 that selects from among a plurality of evaluators 130, such as an evaluator 130a, an evaluator 130b, and an evaluator 130c, to analyze (evaluate) exception report 110 and exception report 114 to generate exception handling response 112 and exception handling response 116. Each of evaluator 130a, evaluator 130b, and evaluator 130c may each comprise AI (or machine learning, ML, used synonymously herein) in the form of an AI model (or ML model). In some examples, plurality of evaluators 130 comprises region-specific evaluators and/or proprietary evaluators (private and specific to an organization).

A shadow evaluator 132 also receives at least exception report 110 and generates a shadow exception handling response 134 that is used for determining whether to upgrade any of plurality of evaluators 130 with shadow evaluator 132. A database 140 stores exception report 110 (the sanitized version), exception handling response 112, and also the sanitized version of exception report 114 and exception handling response 116, which may be used for further training to be used for training the AI models of plurality of evaluators 130. Database 140 also stores shadow exception handling response 134 and an exception event history 142, which has the sanitized version of exception report 114 and exception handling response 116, and is used for determining whether an exception is being repeated, and which indicates that a different exception handling response is needed (because the prior exception handling response was ineffective). Although database 140 is illustrated as a single storage location, multiple storage locations, virtual storage solutions, and distributed storage may be used.

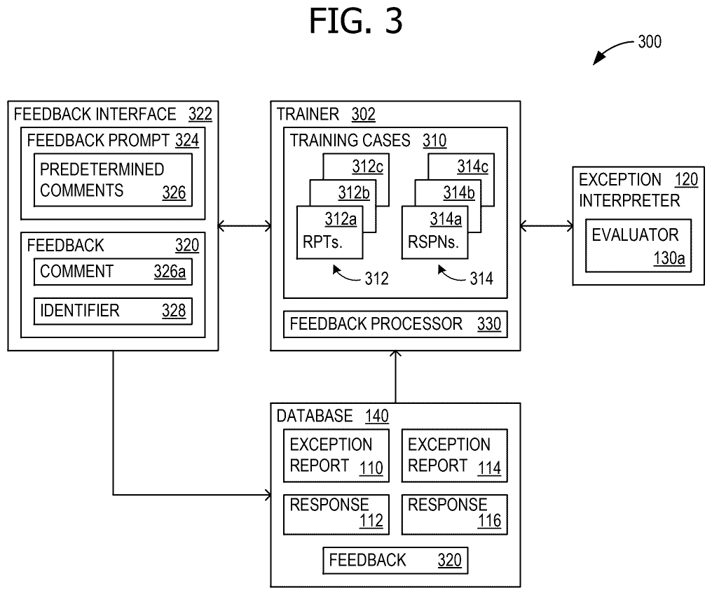

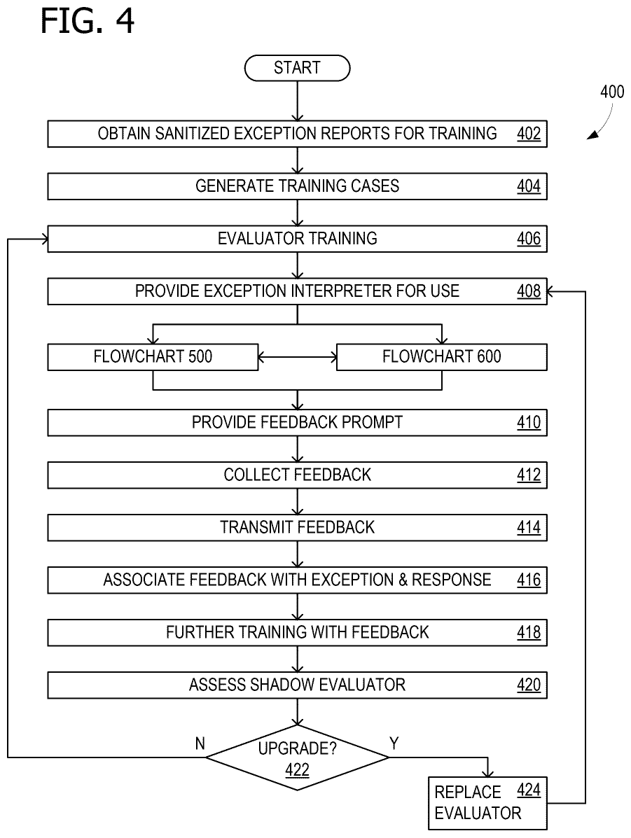

An exception interpreter trainer 302 performs training of plurality of evaluators 130, as described in relation to FIG. 3. The operation of architecture 100 is described in further detail in relation to FIGS. 4-6.

FIGS. 2A, 2B, and 2C illustrate software application 200 in various forms that may be used with examples of architecture 100. FIG. 2A shows source code 202 of software application 200, with a try passage 204 and a catch passage 210. Try passage 204 has an instruction 206 that causes an exception 212, and catch passage 210 catches exception 212. In some examples, exception 212 is an exception of a third party resource 216 (e.g., an external API). Catch passage 210 has an instruction 214 that transmits exception report 110 and exception report 114 to exception interpreter 120, each of which indicates exception 212. FIG. 2B illustrates source code 202a using the syntax for Java and c type languages, and FIG. 2C illustrates source code 202a using the syntax for Visual Basic type languages.

FIG. 3 illustrates a training arrangement 300 that may be used with examples of the architecture of FIG. 1. Exception interpreter trainer 302 performs training of exception interpreter 120, for example training of evaluator 130a, evaluator 130b, and evaluator 130c. Exception interpreter trainer 302 uses a plurality of exception training cases 310, which includes a plurality of exception reports 312 and a plurality of exception handling responses 314, for at least initial training. Plurality of exception reports 312 represents a plurality of differing exception types, such as enough different types of exceptions to provide robust training for exception interpreter 120.

Plurality of exception training cases 310 may grow over time, for example by pulling historical examples from database 140. Database 140 is shown as holding the sanitized version of exception report 110, exception handling response 112, the sanitized version of exception report 114, and exception handling response 116.

A feedback interface 322 provides a feedback prompt 324, for example to programmer 102, to enable determination of the effectiveness of exception handling response 112 and exception handling response 116. In some examples, feedback prompt 324 uses a set of predetermined comments 326 that is tailored for suitability as training material. Feedback 320, which may be provided by programmer 102 in response to feedback prompt 324, includes a selected comment 326a (selected from among set of predetermined comments 326), and a unique identifier 328 that enables a feedback processor 330 to associate feedback 320 with the properly corresponding exception report and exception handling response. Feedback 320 is used by exception interpreter trainer 302 for on-going training of exception interpreter 120 and may also be stored in database 140.

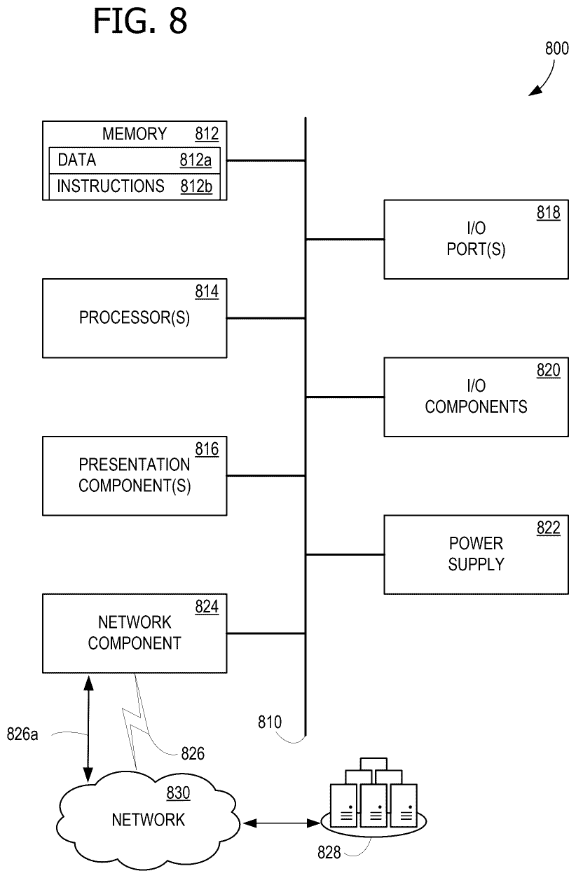

FIG. 4 shows a flowchart 400 illustrating exemplary operations that may be performed by architecture 100 and training arrangement 300. In some examples, operations described for flowchart 400 are performed by computing device 800 of FIG. 8. Flowchart 400 commences with sanitizing plurality of exception reports 312 of sensitive information in operation 402. Sanitizing an exception report of sensitive information comprises deleting at least a portion of the sensitive information, and/or anonymizing or pseudonymizing at least a portion of the sensitive information.

Operation 404 generates plurality of exception training cases 310, for example by labeling plurality of exception handling responses 314 as to effectiveness. Each exception training case of plurality of exception training cases 310 identifies an exception handling response as corresponding to an exception report. In this way, each exception handling response of plurality of exception handling responses 314 is identified as corresponding to an exception report of plurality of exception reports 312. Exception interpreter trainer 302 uses plurality of exception reports 312 and plurality of exception handling responses 314 (i.e., plurality of exception training cases 310) to train evaluator 130a (and the others) in operation 406. Exception interpreter 120 is provided for users in operation 408, for example, as part of a cloud based service.

Flowcharts 500 and 600 are performed next, at least partially in parallel. Operation 410 provides feedback prompt 324 (e.g., a user interface, UI, an API, or an automated tool), and feedback prompt 324 collects feedback 320 in operation 412. Feedback 320 indicates effectiveness of exception handling response 112 for responding to exception 212 indicated in exception report 110, or effectiveness of exception handling response 116 for responding to exception 212 indicated in exception report 114. In some examples, feedback 320 comprises selected comment 326a from set of predetermined comments 326, and/or unique identifier 328 that is used to enable determination by feedback processor 330 that feedback 320 is for exception report 110 and exception handling response 112 (or exception report 114 and exception handling response 116).

Feedback 320 is transmitted to, and received by, exception interpreter trainer 302 in operation 414, and stored associated with the proper exception report and exception handling response in operation 416. The association may be a tag in one or more of the files, metadata associated with one or more of the files, and/or storing files in a common directory (folder). In operation 418, exception interpreter trainer 302 uses feedback 320 to further train exception interpreter 120.

The performance of shadow evaluator 132 is evaluated in operation 420, such as by comparing shadow exception handling response 134 with responses known to be effective (e.g., from plurality of training cases 310) and determining whether the performance of shadow evaluator 132 meets, exceeds, or falls below the performance of evaluator 130a. Decision operation 422 determines whether shadow evaluator 132 should be used in an upgrade of exception interpreter 120. If so, based on at least the performance of shadow evaluator 132, shadow evaluator 132 replaces evaluator 130a in operation 424, and flowchart 400 returns to operation 408. Otherwise, flowchart 400 returns to operation 406. In some examples, shadow evaluator 132 and evaluator 130a are swapped, based on the relative performance of the models, and evaluator 130a is send for additional training or development. This permits “go forward” and “rollback” types of configuration management.

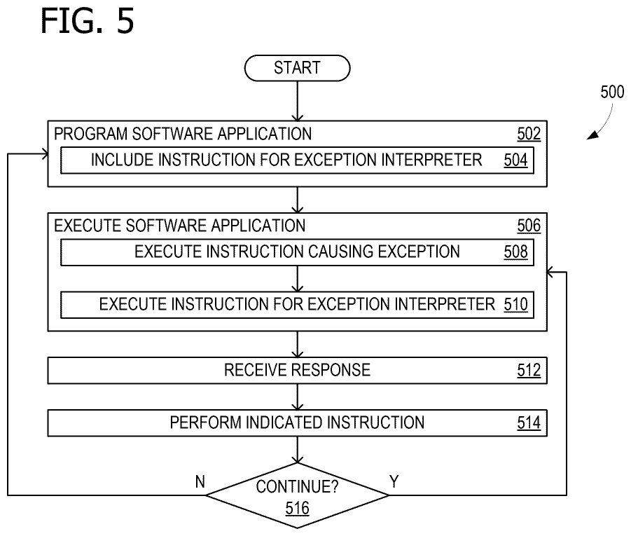

FIG. 5 shows a flowchart 500 illustrating exemplary operations that may be performed by architecture 100. In some examples, operations described for flowchart 500 are performed by computing device 800 of FIG. 8. Flowchart 500 commences with programmer 102 programming software application 200 using IDE 104, in operation 502. This includes programming software application 200 to transmit exception report 110 to exception interpreter 120 in operation 504, e.g., by providing try passage 204 and catch passage 210 in source code 202 of software application 200. Try passage 204 comprises instruction 206 that is operable to cause exception 212, and catch passage 210 is operable to catch exception 212 and comprises instruction 214 that is operable to transmit exception report 110 to exception interpreter 120.

Software application 200 is executed in operation 506, either within IDE 104, or outside of IDE 104, within execution environment 108. Operation 506 includes at least operations 508 and 510, and in some scenarios, also operations 512 and 514. Operation 508 executes instruction 206 in try passage 204, which causes exception 212, and operation 510 catches exception 212 and executes instruction 214 to transmit exception report 110 to exception interpreter 120.

Software application 200 receives exception handling response 112 (from exception interpreter 120) in operation 512, and software application 200 or IDE 104 performs instruction 113 indicated in exception handling response 112 in operation 514. Decision operation 516 determines whether to continue executing software application 200. If yes, then flowchart 500 returns to operation 506 to perform instruction 113, such as retrying immediately, or waiting and retrying. However, if instruction 113 indicates a change to software application 200, flowchart 500 returns to operation 502 and operation 514 (performing instruction 113) is performed outside of software application 200 executing.

If flowchart returns to operation 506, in the next pass, the items acted upon are different. For example, operation 510 transmits exception report 114 to exception interpreter 120, operation 512 receives exception handling response 116, and operation 514 performs instruction 117 indicated in exception handling response 116.

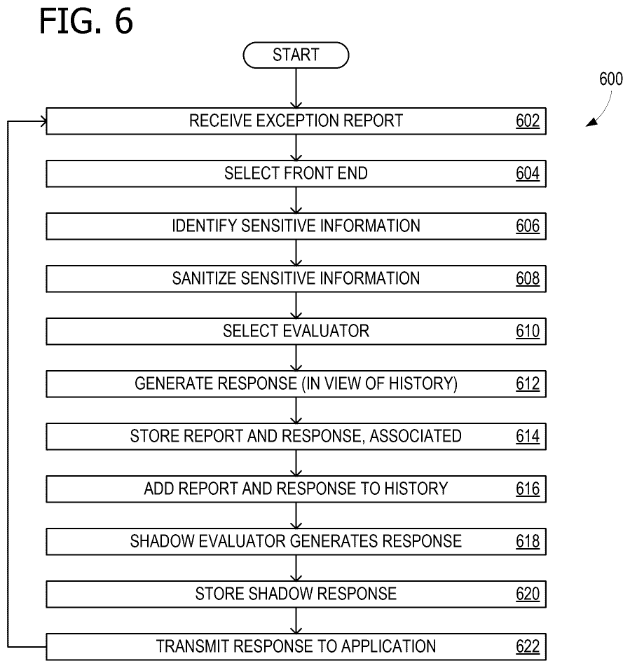

FIG. 6 shows a flowchart 600 illustrating exemplary operations that may be performed by architecture 100. In some examples, operations described for flowchart 600 are performed by computing device 800 of FIG. 8. Flowchart 600 commences with exception interpreter 120 receiving exception report 110 from software application 200, in operation 602. Load balancer 122 selects front end 124a from plurality of exception interpreter service front ends 124 in operation 604. Front end 124a identifies sensitive information 111 within exception report 110 in operation 606 and sanitizes exception report 110 of sensitive information 111 in operation 608.

Load balancer 126 selects evaluator 130a from plurality of evaluators 130 in operation 610, and evaluator 130a evaluating exception report 110 to generate exception handling response 112 in operation 612. In some examples, exception handling response 112 may be any of: retry, wait and retry, try a different resource, abort a process, generate an alarm, suggest an instruction change, and change syntax. In some examples, evaluator 130a also evaluates exception event history 142 to determine whether exception 212 has been previously encountered, and whether a prior exception handling response was attempted and proven to be ineffective. In such scenarios, the new exception handling response will likely be different, such as by increasing a wait period, or another difference.

Operation 614 stores the sanitized exception report 110 and exception handling response 112 as associated together, and operation 616 adds exception report 110 and exception handling response 112 to exception event history 142. The association may be a tag in one or more of the files, metadata associated with one or more of the files, and/or storing files in a common directory (folder). Exception event history 142 now includes exception report 110 and exception handling response 112, so they may be considered during later occurrences of operation 612.

In operation 618, shadow evaluator 132 also evaluates exception report 110, to generate shadow exception handling response 134, which is stored associated with exception handling response 112, in operation 620. In operation 622, exception handling response 112 is transmitted to software application 200 or execution environment 108 in which software application 200 is executing.

Flowchart 600 returns to operation 602 for as long as software application 200 continues to execute. In the next pass, the items acted upon are different. For example, operation 602 is receiving exception report 114, which in this example scenario, indicates the same exception 212 as was indicated by exception report 110. Operation 606 is identifying sensitive information 115 within exception report 114, and operation 608 is sanitizing exception report 114 of sensitive information 115. Operation 612 is evaluating exception report 114 and exception event history 142, to generate exception handling response 116, which is different than exception handling response 112 (because exception handling response 112 was ineffective). For example, a wait time in instruction 117 may be lengthened compared to the corresponding wait time in instruction 113, or instruction 117 may be completely different than instruction 113. Operation 618 is adding exception report 114 and exception handling response 116 to exception event history 142, in the event that exception 212 is identified yet again. Finally, operation 622 is transmitting exception handling response 116 to software application 200 or execution environment 108.

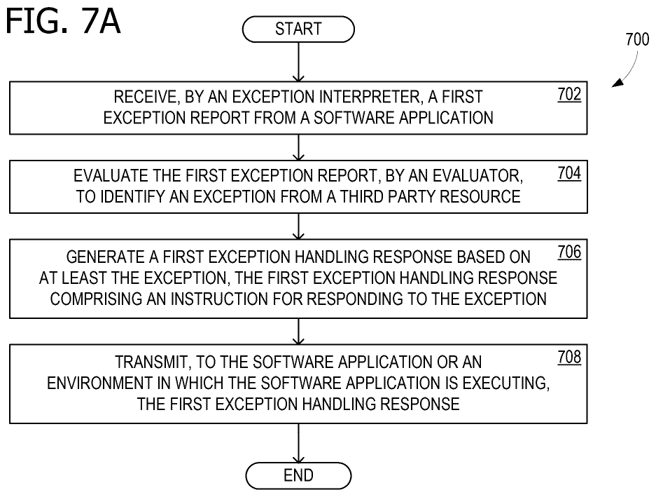

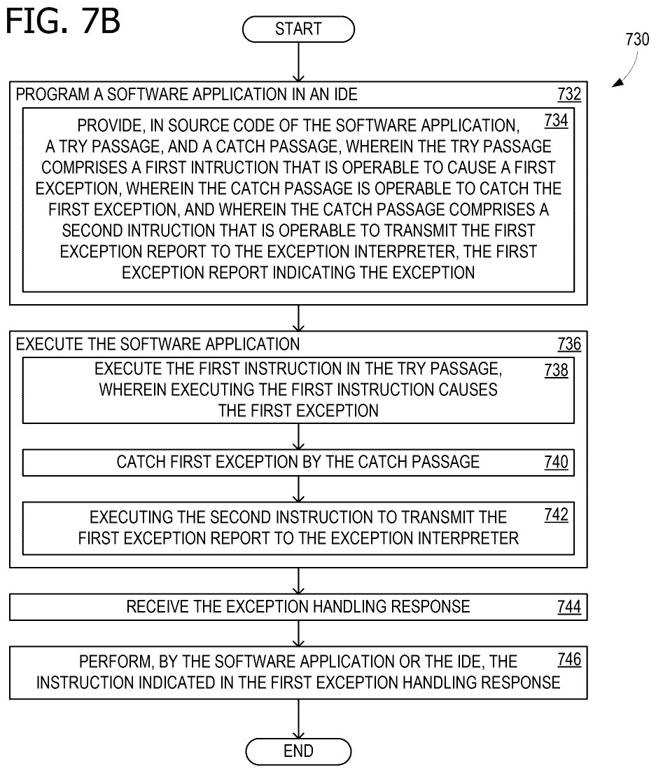

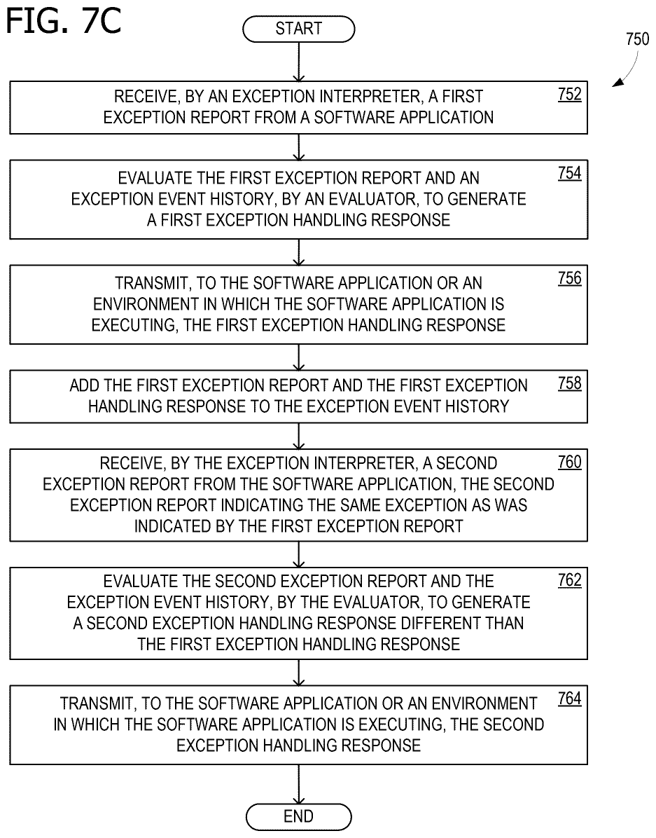

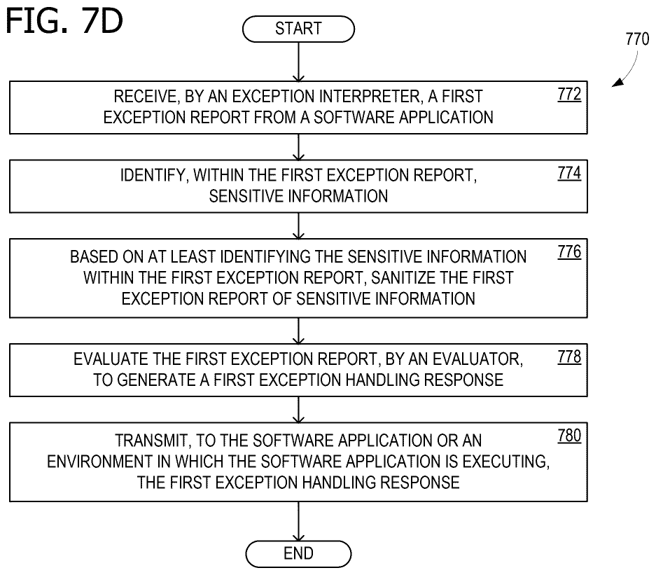

FIG. 7A shows a flowchart 700 illustrating exemplary operations that may be performed by architecture 100. In some examples, operations described for flowchart 700 are performed by computing device 800 of FIG. 8. Flowchart 700 commences with operation 702, which includes receiving, by an exception interpreter, a first exception report from a software application. Operation 704 includes evaluating the first exception report, by an evaluator, to identify an exception from a third party resource.

Operation 706 includes generating a first exception handling response based on at least the exception, the first exception handling response comprising an instruction for responding to the exception. Operation 708 includes transmitting, to the software application or an environment in which the software application is executing, the first exception handling response.

FIG. 7B shows a flowchart 730 illustrating exemplary operations that may be performed by architecture 100. In some examples, operations described for flowchart 730 are performed by computing device 800 of FIG. 8. Flowchart 730 commences with operation 732, which includes programming a software application in an IDE, and which is performed using operation 734, which includes providing, in source code of the software application, a try passage and a catch passage, wherein the try passage comprises a first instruction that is operable to cause a first exception, wherein the catch passage is operable to catch the first exception, and wherein the catch passage comprises a second instruction that is operable to transmit the first exception report to the exception interpreter, the first exception report indicating the exception.

Operation 736 includes executing the software application, which is performed using operations 738-742. Operation 738 includes executing the first instruction in the try passage, wherein executing the first instruction causes the exception. Operation 740 includes catching first exception by the catch passage. Operation 742 includes executing the second instruction to transmit the first exception report to the exception interpreter. Operation 744 includes receiving the first exception handling response. Operation 746 includes performing, by the software application or the IDE, the instruction indicated in the first exception handling response.

FIG. 7C shows a flowchart 750 illustrating exemplary operations that may be performed by architecture 100. In some examples, operations described for flowchart 750 are performed by computing device 800 of FIG. 8. Flowchart 750 commences with operation 752, which includes receiving, by an exception interpreter, a first exception report from a software application. Operation 754 includes evaluating the first exception report and an exception event history, by an evaluator, to generate a first exception handling response.

Operation 756 includes transmitting, to the software application or an environment in which the software application is executing, the first exception handling response. Operation 758 includes adding the first exception report and the first exception handling response to the exception event history. Operation 760 includes receiving, by the exception interpreter, a second exception report from the software application, the second exception report indicating the same exception as was indicated by the first exception report.

Operation 762 includes evaluating the second exception report and the exception event history, by the evaluator, to generate a second exception handling response different than the first exception handling response. Operation 764 includes transmitting, to the software application or an environment in which the software application is executing, the second exception handling response.

FIG. 7D shows a flowchart 770 illustrating exemplary operations that may be performed by architecture 100. In some examples, operations described for flowchart 770 are performed by computing device 800 of FIG. 8. Flowchart 770 commences with operation 772, which includes receiving, by an exception interpreter, a first exception report from a software application. Operation 774 includes identifying, within the first exception report, sensitive information.

Operation 776 includes, based on at least identifying the sensitive information within the first exception report, sanitizing the first exception report of sensitive information. Operation 778 includes evaluating the first exception report, by an evaluator, to generate a first exception handling response. Operation 780 includes transmitting, to the software application or an environment in which the software application is executing, the first exception handling response.

### ADDITIONAL EXAMPLES

An example system comprises: a processor; and a computer-readable medium storing instructions that are operative upon execution by the processor to: receive, by an exception interpreter, a first exception report from a software application; evaluate the first exception report, by an evaluator, to identify an exception from a third party resource; generate a first exception handling response based on at least the exception, the first exception handling response comprising an instruction for responding to the exception; and transmit, to the software application or an environment in which the software application is executing, the first exception handling response.

Another example system comprises: a processor; and a computer-readable medium storing instructions that are operative upon execution by the processor to: program a software application in an IDE, wherein programming the software application to transmit the first exception report to the exception interpreter comprises: providing, in source code of the software application, a try passage and a catch passage, wherein the try passage comprises a first instruction that is operable to cause a first exception, wherein the catch passage is operable to catch the first exception, and wherein the catch passage comprises a second instruction that is operable to transmit the first exception report to the exception interpreter, the first exception report indicating the exception; execute the software application, wherein executing the software application comprises: executing the first instruction in the try passage, wherein executing the first instruction causes the exception; catching first exception by the catch passage; and executing the second instruction to transmit the first exception report to the exception interpreter; receive the first exception handling response; and perform, by the software application or the IDE, the instruction indicated in the first exception handling response.

Another example system comprises: a processor; and a computer-readable medium storing instructions that are operative upon execution by the processor to: receive, by an exception interpreter, a first exception report from a software application; evaluate the first exception report and an exception event history, by an evaluator, to generate a first exception handling response; transmit, to the software application or an environment in which the software application is executing, the first exception handling response; add the first exception report and the first exception handling response to the exception event history; receive, by the exception interpreter, a second exception report from the software application, the second exception report indicating the same exception as was indicated by the first exception report; evaluate the second exception report and the exception event history, by the evaluator, to generate a second exception handling response different than the first exception handling response; and transmit, to the software application or an environment in which the software application is executing, the second exception handling response.

Another example system comprises: a processor; and a computer-readable medium storing instructions that are operative upon execution by the processor to: receive, by an exception interpreter, a first exception report from a software application; identify, within the first exception report, sensitive information; based on at least identifying the sensitive information within the first exception report, sanitize the first exception report of sensitive information; evaluate the first exception report, by an evaluator, to generate a first exception handling response; and transmit, to the software application or an environment in which the software application is executing, the first exception handling response.

An example computer-implemented method comprises: receiving, by an exception interpreter, a first exception report from a software application; evaluating the first exception report, by an evaluator, to identify an exception from a third party resource; generating a first exception handling response based on at least the exception, the first exception handling response comprising an instruction for responding to the exception; and transmitting, to the software application or an environment in which the software application is executing, the first exception handling response.

Another example computer-implemented method comprises: programming a software application in an IDE, wherein programming the software application to transmit the first exception report to the exception interpreter comprises: providing, in source code of the software application, a try passage and a catch passage, wherein the try passage comprises a first instruction that is operable to cause a first exception, wherein the catch passage is operable to catch the first exception, and wherein the catch passage comprises a second instruction that is operable to transmit the first exception report to the exception interpreter, the first exception report indicating the exception; executing the software application, wherein executing the software application comprises: executing the first instruction in the try passage, wherein executing the first instruction causes the exception; catching first exception by the catch passage; and executing the second instruction to transmit the first exception report to the exception interpreter; receiving the first exception handling response; and performing, by the software application or the IDE, the instruction indicated in the first exception handling response.

Another example computer-implemented method comprises: receiving, by an exception interpreter, a first exception report from a software application; evaluating the first exception report and an exception event history, by an evaluator, to generate a first exception handling response; transmitting, to the software application or an environment in which the software application is executing, the first exception handling response; adding the first exception report and the first exception handling response to the exception event history; receiving, by the exception interpreter, a second exception report from the software application, the second exception report indicating the same exception as was indicated by the first exception report; evaluating the second exception report and the exception event history, by the evaluator, to generate a second exception handling response different than the first exception handling response; and transmitting, to the software application or an environment in which the software application is executing, the second exception handling response.

Another example computer-implemented method comprises: receiving, by an exception interpreter, a first exception report from a software application; identifying, within the first exception report, sensitive information; based on at least identifying the sensitive information within the first exception report, sanitizing the first exception report of sensitive information; evaluating the first exception report, by an evaluator, to generate a first exception handling response; and transmitting, to the software application or an environment in which the software application is executing, the first exception handling response.

One or more example computer storage devices have computer-executable instructions stored thereon, which, on execution by a computer, cause the computer to perform operations comprising: receiving, by an exception interpreter, a first exception report from a software application; evaluating the first exception report, by an evaluator, to identify an exception from a third party resource; generating a first exception handling response based on at least the exception, the first exception handling response comprising an instruction for responding to the exception; and transmitting, to the software application or an environment in which the software application is executing, the first exception handling response.

One or more additional example computer storage devices have computer-executable instructions stored thereon, which, on execution by a computer, cause the computer to perform operations comprising: programming a software application in an IDE, wherein programming the software application to transmit the first exception report to the exception interpreter comprises: providing, in source code of the software application, a try passage and a catch passage, wherein the try passage comprises a first instruction that is operable to cause a first exception, wherein the catch passage is operable to catch the first exception, and wherein the catch passage comprises a second instruction that is operable to transmit the first exception report to the exception interpreter, the first exception report indicating the exception; executing the software application, wherein executing the software application comprises: executing the first instruction in the try passage, wherein executing the first instruction causes the exception; catching first exception by the catch passage; and executing the second instruction to transmit the first exception report to the exception interpreter; receiving the first exception handling response; and performing, by the software application or the IDE, the instruction indicated in the first exception handling response.

One or more additional example computer storage devices have computer-executable instructions stored thereon, which, on execution by a computer, cause the computer to perform operations comprising: receiving, by an exception interpreter, a first exception report from a software application; evaluating the first exception report and an exception event history, by an evaluator, to generate a first exception handling response; transmitting, to the software application or an environment in which the software application is executing, the first exception handling response; adding the first exception report and the first exception handling response to the exception event history; receiving, by the exception interpreter, a second exception report from the software application, the second exception report indicating the same exception as was indicated by the first exception report; evaluating the second exception report and the exception event history, by the evaluator, to generate a second exception handling response different than the first exception handling response; and transmitting, to the software application or an environment in which the software application is executing, the second exception handling response.

One or more additional example computer storage devices have computer-executable instructions stored thereon, which, on execution by a computer, cause the computer to perform operations comprising: receiving, by an exception interpreter, a first exception report from a software application; identifying, within the first exception report, sensitive information; based on at least identifying the sensitive information within the first exception report, sanitizing the first exception report of sensitive information; evaluating the first exception report, by an evaluator, to generate a first exception handling response; and transmitting, to the software application or an environment in which the software application is executing, the first exception handling response.

Alternatively, or in addition to the other examples described herein, examples include any combination of the following:
storing the sanitized the first exception report and the first exception handling response as associated together;
receiving, by an exception interpreter trainer, feedback indicating an effectiveness of the first exception handling response for responding to an exception indicated in the first exception report;
storing the feedback associated with the sanitized first exception report and the first exception handling response;
using the feedback to further train the exception interpreter;
the first exception handling response comprises an instruction selected from the list consisting of: retry, wait and retry, try a different resource, abort a process, generate an alarm, suggest an instruction change, and change syntax;
programming the software application to transmit the first exception report to the exception interpreter;
providing, in source code of the software application, a try passage and a catch passage;
the try passage comprises a first instruction that is operable to cause a first exception;
the catch passage is operable to catch the exception;
the catch passage comprises a second instruction that is operable to transmit the first exception report to the exception interpreter;
the first exception report indicates the exception;
executing the software application;
executing the first instruction in the try passage;
executing the first instruction causes the exception;
catching the first exception by the catch passage;
executing the second instruction to transmit the first exception report to the exception interpreter;
receiving the first exception handling response;
the evaluator comprises an AI model;
training the evaluator, using a plurality of exception reports and a plurality of exception handling responses, wherein the plurality of exception reports represents a plurality of differing exception types;
receiving, by the exception interpreter, a second exception report from the software application, the second exception report indicating the same exception as was indicated by the first exception report;
evaluating the second exception report and an exception event history, by the evaluator, to generate a second exception handling response different than the first exception handling response;
transmitting, to the software application or an environment in which the software application is executing, the second exception handling response;
the exception interpreter comprises a first load balancer, a plurality of exception interpreter service front ends, a second load balancer, and a plurality of evaluators;
selecting, by the first load balancer, a first front end from the plurality of exception interpreter service front ends;
the first front end sanitizes the first exception report;
selecting, by the second load balancer, the evaluator from the plurality of evaluators;
the software application is executing within the IDE;
generating a plurality of exception training cases, each exception training case of the plurality of exception training cases identifying an exception handling response as corresponding to an exception report;
each exception handling response of the plurality of exception handling responses is identified as corresponding to an exception report of the plurality of exception reports;
the plurality of exception reports is sanitized of sensitive information;
sanitizing an exception report of sensitive information comprises: deleting at least a portion of the sensitive information; and/or anonymizing or pseudonymizing at least a portion of the sensitive information;
the exception interpreter is provided as part of a cloud based service;
programming the software application in an IDE;
the IDE is connected to a cloud service hosting the exception interpreter;
the IDE comprises Dot Net and/or Visual Studio;
the software application comprises an interpreted language;
executing the software application within the IDE;
executing the software application within an environment, outside of the IDE;
the environment comprises Dot Net;
the exception is an exception of a third party resource;
transmitting, by the software application or the IDE, the first exception report to the exception interpreter;
the plurality of evaluators comprises region-specific evaluators;
the software application receives the first exception handling response;
performing, by the software application or the IDE, the instruction indicated in the first exception handling response;
identifying, within the second exception report, sensitive information;
based on at least identifying the sensitive information within the second exception report, sanitizing the second exception report of sensitive information;
adding the first exception report and the first exception handling response to the exception event history;
the exception event history includes the first exception report and the first exception handling response;
performing, by the software application or the IDE, the instruction indicated in the second exception handling response;
the second exception handling response comprises an instruction selected from the list consisting of: retry, wait and retry, try a different resource, abort a process, generate an alarm, suggest an instruction change, and change syntax;
providing a feedback prompt;
the feedback prompt comprises a set of predetermined comments;
collecting, by the feedback prompt, the feedback;
the feedback comprises an unique identifier;
the feedback comprises a selected comment from the set of predetermined comments;
transmitting the feedback to the exception interpreter trainer;
evaluating the first exception report, by a shadow evaluator, to generate a shadow exception handling response;
storing the shadow exception handling response associated with the first exception handling response;
evaluating performance of the shadow evaluator; and
based on at least the performance of the shadow evaluator, replacing the evaluator with the shadow evaluator.

While the aspects of the disclosure have been described in terms of various examples with their associated operations, a person skilled in the art would appreciate that a combination of operations from any number of different examples is also within scope of the aspects of the disclosure.

### Example Operating Environment

FIG. 8 is a block diagram of an example computing device 800 (e.g., a computer storage device) for implementing aspects disclosed herein, and is designated generally as computing device 800. In some examples, one or more computing devices 800 are provided for an on-premises computing solution. In some examples, one or more computing devices 800 are provided as a cloud computing solution. In some examples, a combination of on-premises and cloud computing solutions are used. Computing device 800 is but one example of a suitable computing environment and is not intended to suggest any limitation as to the scope of use or functionality of the examples disclosed herein, whether used singly or as part of a larger set.

Neither should computing device 800 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 800 includes a bus 810 that directly or indirectly couples the following devices: computer storage memory 812, one or more processors 814, one or more presentation components 816, input/output (I/O) ports 818, I/O components 820, a power supply 822, and a network component 824. While computing device 800 is depicted as a seemingly single device, multiple computing devices 800 may work together and share the depicted device resources. For example, memory 812 may be distributed across multiple devices, and processor(s) 814 may be housed with different devices.

Bus 810 represents what may be one or more buses (such as an address bus, data bus, or a combination thereof). Although the various blocks of FIG. 8 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 8 and the references herein to a “computing device.” Memory 812 may take the form of the computer storage media referenced below and operatively provide storage of computer-readable instructions, data structures, program modules and other data for the computing device 800. In some examples, memory 812 stores one or more of an operating system, a universal application platform, or other program modules and program data. Memory 812 is thus able to store and access data 812a and instructions 812b that are executable by processor 814 and configured to carry out the various operations disclosed herein. Thus, computing device 800 comprises a computer storage device having computer-executable instructions 812b stored thereon.

In some examples, memory 812 includes computer storage media. Memory 812 may include any quantity of memory associated with or accessible by the computing device 800. Memory 812 may be internal to the computing device 800 (as shown in FIG. 8), external to the computing device 800 (not shown), or both (not shown). Additionally, or alternatively, the memory 812 may be distributed across multiple computing devices 800, for example, in a virtualized environment in which instruction processing is carried out on multiple computing devices 800. For the purposes of this disclosure, “computer storage media,” “computer storage memory,” “memory,” and “memory devices” are synonymous terms for the memory 812, and none of these terms include carrier waves or propagating signaling.

Processor(s) 814 may include any quantity of processing units that read data from various entities, such as memory 812 or I/O components 820. Specifically, processor(s) 814 are programmed to execute computer-executable instructions for implementing aspects of the disclosure. The instructions may be performed by the processor, by multiple processors within the computing device 800, or by a processor external to the client computing device 800. In some examples, the processor(s) 814 are programmed to execute instructions such as those illustrated in the flow charts discussed below and depicted in the accompanying drawings. Moreover, in some examples, the processor(s) 814 represents an implementation of analog techniques to perform the operations described herein. For example, the operations may be performed by an analog client computing device 800 and/or a digital client computing device 800. Presentation component(s) 816 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 800, across a wired connection, or in other ways. I/O ports 818 allow computing device 800 to be logically coupled to other devices including I/O components 820, some of which may be built in. Example I/O components 820 include, for example but without limitation, a microphone, joystick, game pad, satellite dish, scanner, printer, wireless device, etc.

Computing device 800 may operate in a networked environment via the network component 824 using logical connections to one or more remote computers. In some examples, the network component 824 includes a network interface card and/or computer-executable instructions (e.g., a driver) for operating the network interface card. Communication between the computing device 800 and other devices may occur using any protocol or mechanism over any wired or wireless connection. In some examples, network component 824 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 824 communicates over wireless communication link 826 and/or a wired communication link 826a to a remote resource 828 (e.g., a cloud resource) across network 830. Various different examples of communication links 826 and 826a include a wireless connection, a wired connection, and/or a dedicated link, and in some examples, at least a portion is routed through the internet.

Although described in connection with an example computing device 800, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a computer-readable medium storing instructions that are operative upon execution by the processor to:
receive, by an exception interpreter, a first exception report from a software application;
evaluate the first exception report, by an evaluator, to identify an exception from a third party resource;
generate a first exception handling response based on at least the exception, the first exception handling response comprising an instruction for responding to the exception; and
transmit, to the software application or an environment in which the software application is executing, the first exception handling response.

2. The system of claim 1, wherein the instructions are further operative to:
store the first exception report and the first exception handling response as associated together;
receive, by an exception interpreter trainer, feedback indicating an effectiveness of the first exception handling response for responding to an exception indicated in the first exception report;
store the feedback associated with the first exception report and the first exception handling response; and
use the feedback to further train the exception interpreter.

3. The system of claim 1, wherein the first exception handling response comprises an instruction selected from the list consisting of:
retry, wait and retry, try a different resource, abort a process, generate an alarm, suggest an instruction change, and change syntax.

4. The method of claim 1, further comprising:
execute the software application, wherein executing the software application comprises:
executing a first instruction in a try passage, wherein executing the first instruction causes the exception;
catching the first exception by a catch passage; and
executing a second instruction to transmit the first exception report to the exception interpreter; and
receive the first exception handling response.

5. The method of claim 1, wherein the evaluator comprises an artificial intelligence (AI) model, and wherein the instructions are further operative to:
train the evaluator, using a plurality of exception reports and a plurality of exception handling responses, wherein the plurality of exception reports represents a plurality of differing exception types.

6. The system of claim 1, wherein the instructions are further operative to:
receive, by the exception interpreter, a second exception report from the software application, the second exception report indicating a same exception as was indicated by the first exception report;
evaluate the second exception report and an exception event history, by the evaluator, to generate a second exception handling response different than the first exception handling response; and
transmit, to the software application or an environment in which the software application is executing, the second exception handling response.

7. The system of claim 1, wherein the exception interpreter comprises a first load balancer, a plurality of exception interpreter service front ends, a second load balancer, and a plurality of evaluators, and wherein the instructions are further operative to:
select, by the first load balancer, a first front end from the plurality of exception interpreter service front ends, wherein the first front end sanitizes the first exception report; and
select, by the second load balancer, the evaluator from the plurality of evaluators.

8. A computer-implemented method comprising:
receiving, by an exception interpreter, a first exception report from a software application;
evaluating the first exception report, by an evaluator, to identify an exception from a third party resource;
generating a first exception handling response based on at least the exception, the first exception handling response comprising an instruction for responding to the exception; and
transmitting, to the software application or an environment in which the software application is executing, the first exception handling response.

9. The method of claim 8, further comprising:
storing the first exception report and the first exception handling response as associated together;
receiving, by an exception interpreter trainer, feedback indicating an effectiveness of the first exception handling response for responding to an exception indicated in the first exception report;
storing the feedback associated with the first exception report and the first exception handling response; and
using the feedback to further train the exception interpreter.

10. The method of claim 8, wherein the first exception handling response comprises an instruction selected from the list consisting of:
retry, wait and retry, try a different resource, abort a process, generate an alarm, suggest an instruction change, and change syntax.

11. The method of claim 8, further comprising:
programming the software application to transmit the first exception report to the exception interpreter, wherein programming the software application to transmit the first exception report to the exception interpreter comprises:
providing, in source code of the software application, a try passage and a catch passage, wherein the try passage comprises a first instruction that is operable to cause a first exception, wherein the catch passage is operable to catch the first exception, and wherein the catch passage comprises a second instruction that is operable to transmit the first exception report to the exception interpreter, the first exception report indicating the exception;
executing the software application, wherein executing the software application comprises:
executing the first instruction in the try passage, wherein executing the first instruction causes the exception;
catching the first exception by the catch passage; and
executing the second instruction to transmit the first exception report to the exception interpreter; and
receiving the first exception handling response.

12. The method of claim 8, wherein the evaluator comprises an artificial intelligence (AI) model, and wherein the method further comprises:
training the evaluator, using a plurality of exception reports and a plurality of exception handling responses, wherein the plurality of exception reports represents a plurality of differing exception types.

13. The method of claim 8, further comprising:
receiving, by the exception interpreter, a second exception report from the software application, the second exception report indicating a same exception as was indicated by the first exception report;
evaluating the second exception report and an exception event history, by the evaluator, to generate a second exception handling response different than the first exception handling response; and
transmitting, to the software application or an environment in which the software application is executing, the second exception handling response.

14. The method of claim 8, wherein the exception interpreter comprises a first load balancer, a plurality of exception interpreter service front ends, a second load balancer, and a plurality of evaluators, and wherein the method further comprises:
selecting, by the first load balancer, a first front end from the plurality of exception interpreter service front ends, wherein the first front end sanitizes the first exception report; and
selecting, by the second load balancer, the evaluator from the plurality of evaluators.

15. The method of claim 8, wherein the software application is executing within the IDE.

16. A computer storage device having computer-executable instructions stored thereon, which, on execution by a computer, cause the computer to perform operations comprising:
receiving, by an exception interpreter, a first exception report from a software application;
evaluating the first exception report, by an evaluator, to identify an exception from a third party resource;
generating a first exception handling response based on at least the exception, the first exception handling response comprising an instruction for responding to the exception; and
transmitting, to the software application or an environment in which the software application is executing, the first exception handling response.

17. The computer storage device of claim 16, wherein the operations further comprise:
storing the first exception report and the first exception handling response as associated together;
receiving, by an exception interpreter trainer, feedback indicating an effectiveness of the first exception handling response for responding to an exception indicated in the first exception report;
storing the feedback associated with the first exception report and the first exception handling response; and
using the feedback to further train the exception interpreter.

18. The computer storage device of claim 16, wherein the operations further comprise:
executing the software application, wherein executing the software application comprises:
executing a first instruction in a try passage, wherein executing the first instruction causes the exception;
catching the first exception by a catch passage; and
executing a second instruction to transmit the first exception report to the exception interpreter; and
receiving the first exception handling response.

19. The computer storage device of claim 16, wherein the evaluator comprises an artificial intelligence (AI) model, and wherein the wherein the operations further comprise:
training the evaluator, using a plurality of exception reports and a plurality of exception handling responses, wherein the plurality of exception reports represents a plurality of differing exception types.

20. The computer storage device of claim 16, wherein the operations further comprise:
receiving, by the exception interpreter, a second exception report from the software application, the second exception report indicating a same exception as was indicated by the first exception report;
evaluating the second exception report and an exception event history, by the evaluator, to generate a second exception handling response different than the first exception handling response; and
transmitting, to the software application or an environment in which the software application is executing, the second exception handling response.
